(19) United States
(12) Patent Application Publication
(10) Pub. No.: US 2002/0054454 A1
(43) Pub. Date: May 9, 2002

(54) Metal sleeve with precision dimples

(76) Inventors: Shiao-Hua Chen, Palo Alto, CA (US); Tho Pham, Milipitas, CA (US)

Correspondence Address: Ben J. Yorks, IRELL & MANELLA, LLP, 840 Newport Center Drive, Ste 400, Newport Beach, CA, 92660, US

(21) Appl. No.: 09/847,774

(22) Filed: May 1, 2001

Related U.S. Application Data
(60) Provisional application No. 60/246,324, filed on Nov. 6, 2000.

(51) Int. Cl. G11B 17/02

(52) U.S. Cl. 360/99.12

(57) ABSTRACT

A spindle motor assembly that includes a sleeve which couples a disk to a motor hub. The sleeve may have a plurality of protrusions that are in contact with the disks. The sleeve and protrusions center the disk with the motor hub. Centering the disk improves the overall balance of the spindle motor assembly.

### REFERENCE TO CROSS-RELATED APPLICATIONS

This application claims priority to provisional application No. 60/246,324 filed on Nov. 6, 2000.

### BACKGROUND OF THE INVENTION

1. Field of the Invention

The present invention relates to a spindle motor/disk assembly of a hard disk drive.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element for magnetizing the disks and a separate read element for sensing the magnetic fields of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is attached to a flexure arm to create an subassembly commonly referred to as a head gimbal assembly (“HGA”). The HGA's are attached to an actuator arm which has a voice coil motor that can move the heads across the surfaces of the disks.

The disks are rotated by a spindle motor that is mounted to a base plate of the drive. Each disks has a center opening that slides over a hub of the spindle motor. To allow clearance between the disks and spindle motor the inner diameter of the center opening is larger than the outer diameter of the motor hub. The larger center disk opening creates a space between the disks and the hub. The space may allow the disk to be offset from the center of the spindle motor. Offset disks will create an imbalance in the spindle motor/disk assembly.

The imbalance in the spindle motor must be corrected before assembling the motor/disk assembly into a hard disk drive. The spindle motor balancing procedure typically requires the iterative steps of measuring the stability of the motor and then shifting the positions of the disks, adding weights to the assembly, or some other means to balance the motor. Such procedures are a time consuming process that adds to the cost of mass producing hard disk drives.

### BRIEF SUMMARY OF THE INVENTION

One embodiment of the present invention is a spindle motor assembly that includes a sleeve which couples a disk to a motor hub.

### BRIEF DESCRIPTION OF THE DRAWINGS

FIG. 1 is a top view of an embodiment of a hard disk drive of the present invention;

FIG. 2 is a side sectional view of a spindle motor/disk assembly;

FIG. 3 is a top view of a sleeve of the spindle motor/disk assembly; and,

FIG. 4 is a schematic of an electrical system of the hard disk drive.

### DETAILED DESCRIPTION OF THE PREFERRED EMBODIMENT

In general one embodiment of the present invention provides a spindle motor assembly that includes a sleeve which couples a disk to a motor hub. The sleeve may have a plurality of protrusions that are in contact with the disks. The sleeve and protrusions center the disk with the motor hub. Centering the disk improves the overall balance of the spindle motor assembly.

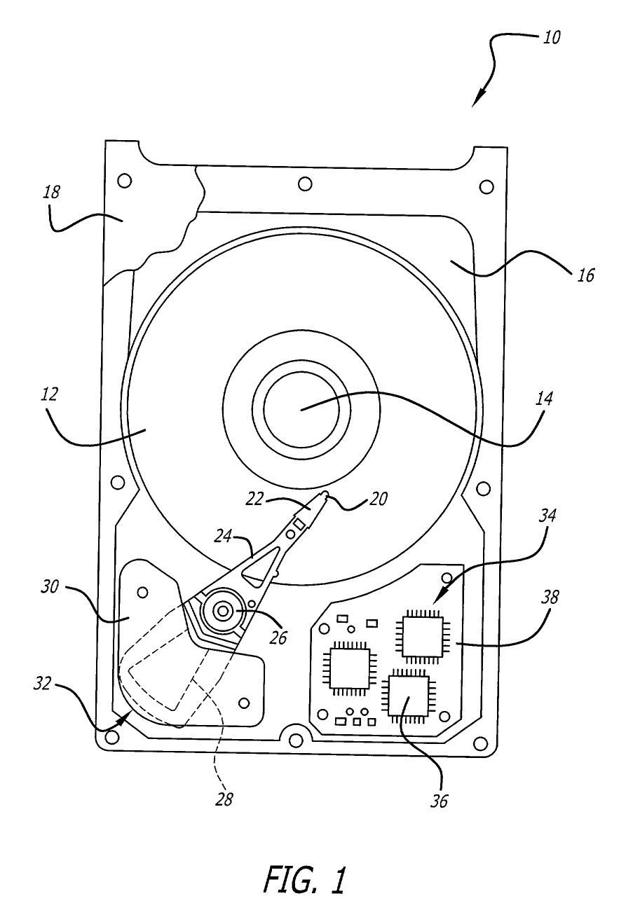

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

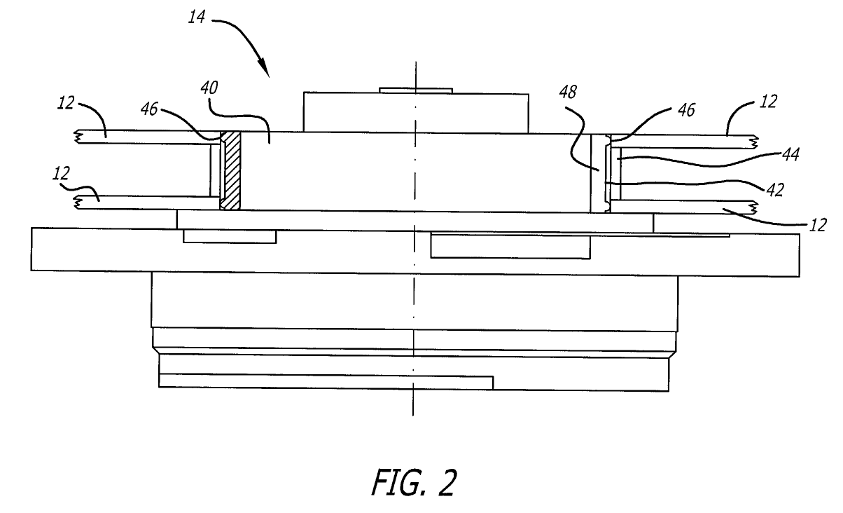

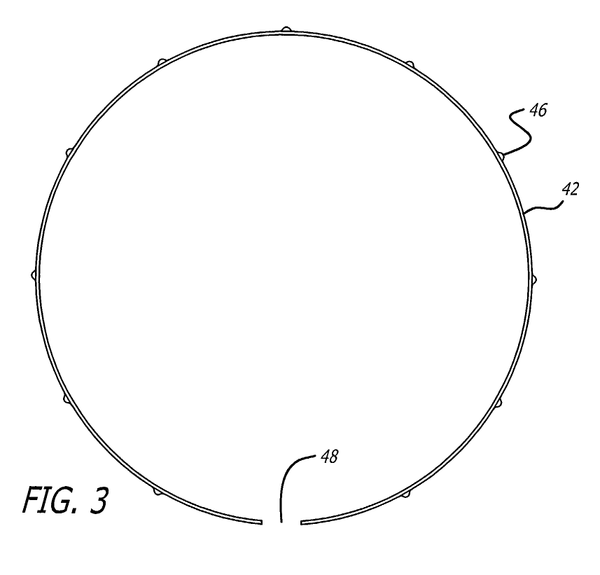

FIG. 2 shows an embodiment of the present invention wherein the disks 12 are coupled to a hub 40 of the spindle motor 14 by sleeve 42. The disks 12 may be separated by a spacer 44 that is also coupled to the motor hub 40 by the sleeve 42. The sleeve 42 may have a plurality of protrusions 46 that come into contact with inner surfaces 48 of the disks 12 and spacer 44. The sleeve 42 and protrusions 46 center the disks 12 and spacer 44 to balance the spindle motor/disk assembly. As shown in FIG. 3, the sleeve 42 may have a slit 48.

The sleeve 42 may be constructed from a metal material such as aluminum, steel, etc. The slit 48 allows the centering sleeve 42 to expand during assembly to slide onto the motor hub 40. The protrusions 46 may be dimples formed in the metal sleeve 42. As shown in FIG. 2, the sleeve 42 preferably extends along the length of the motor hub 40 to center all of the disks 12 and spacer(s) 44 of the spindle motor/disk assembly.

The disks 12 can be assembled onto the spindle motor 14 by initially sliding the sleeve 42 onto the motor hub 40. The dimensions of the centering sleeve 42 and motor hub 40 may be such that the sleeve 42 is slightly deflected in an outward radial direction. The deflection will create an inward force that will retain the sleeve 42 onto the hub 40.

The disks 14 and spacer 44 may then be pushed over the sleeve 42. The dimensions of the center openings may be such that the disks 12 slightly deflect the protrusions 46. The deflection of the protrusions will create spring forces that will reduce relative movement between the disks 12 and the spindle motor 14. This will improve the dynamic balance of the spindle motor/disk assembly. Additionally, the sleeve 42 and protrusions 46 center the disks 12 onto the spindle motor 14, thereby improving both the static and dynamic balance of the spindle motor/disk assembly

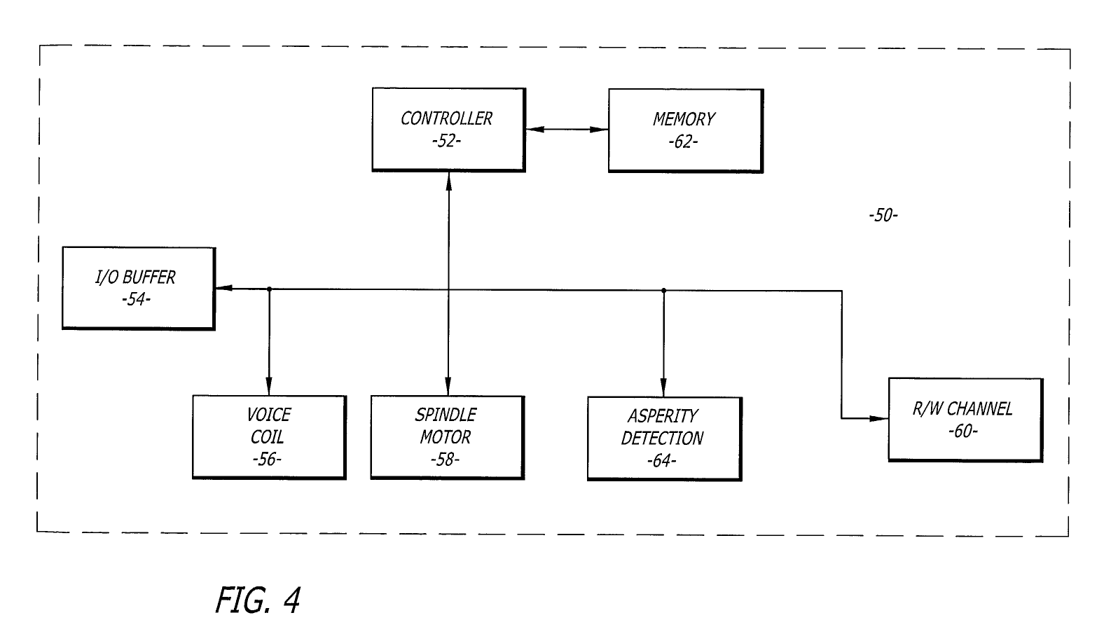

FIG. 4 shows a schematic of an electrical system 50 that can control the disk drive 10. The system 50 includes a controller 52 that is connected to an input/output (I/O) buffer 54, voice coil motor control circuit 56, spindle motor control circuit 58, read/write channel circuit 60, memory 62. The I/O buffer 54 provides an interface with an external source such as a personal computer.

The voice coil control circuit 56 and spindle motor control circuit 58 contain drivers, etc. to control the voice coil motor and spindle motor, respectively. The voice coil motor circuit 56 and spindle motor control circuit 58 operate in accordance with signals, commands, etc. from the controller 52. The controller 52 may be a processor that can perform software routines in accordance with instructions and data to operate the storage and retrieval of information from the disks 12.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A spindle motor assembly for a hard disk drive, comprising:
a motor hub;
a disk; and,
a sleeve located on said motor hub and which has a plurality of protrusions that couple said disk to said motor hub.

2. The assembly of claim 1, further comprising a second disk that is coupled to said motor hub by said sleeve.

3. The assembly of claim 2, further comprising a spacer that separates said first and second disks and is coupled to said motor hub by said sleeve.

4. The assembly of claim 1, where in said sleeve has a slit.

5. The assembly of claim 1, wherein said protrusions are dimples in said sleeve.

6. The assembly of claim 1, wherein said sleeve is constructed from a metal material.

7. A hard disk drive, comprising:
a base plate;
a spindle motor attached to said base plate;
a first disk;
a sleeve located on said spindle motor and which has a plurality of protrusions that couple said disk to said motor hub;
an actuator arm attached to said base plate;
a head attached to said actuator arm and coupled to said disk;
a voice coil motor attached to said actuator arm.

8. The hard disk drive of claim 7, further comprising a second disk that is coupled to said motor hub by said sleeve.

9. The hard disk drive of claim 8, further comprising a spacer that separates said first and second disks and is coupled to said motor hub by said sleeve.

10. The hard disk drive of claim 7, wherein said sleeve has a slit.

11. The hard disk drive of claim 7, wherein said protrusions are dimples in said sleeve.

12. The hard disk drive of claim 7, wherein said sleeve is constructed from a metal material.

13. A method for assembling a spindle motor assembly of a hard disk drive, comprising:
attaching a sleeve to a motor hub, wherein the sleeve has a plurality of protrusions; and,
attaching a first disk to the protrusions of the sleeve.

14. The method of claim 13, further comprising attaching a spacer to the sleeve.

15. The method of claim 14, further comprising attaching a second disk to the sleeve.

16. A spindle motor assembly for a hard disk drive, comprising;
a motor hub;
a first disk; and,
a sleeve located on said motor hub, said sleeve having a plurality of protrusions between said motor hub and said first disk.

17. The assembly of claim 16, further comprising a second disk that is coupled to said motor hub by said sleeve.

18. The assembly of claim 16, further comprising a spacer that separates said first and second disks, wherein protrusion are located between said motor hub and said sleeve.

19. The assembly of claim 16, wherein said sleeve has a slit.

20. The assembly of claim 16, wherein said protrusions are dimples in said sleeve.

21. The assembly of claim 16, wherein said sleeve is constructed from a metal material.
